(19) United States
(12) Patent Application Publication
(10) Pub. No.: US 2016/0064832 A1
(43) Pub. Date: Mar. 3, 2016

(54) MULTI-BAND LOOP ANTENNA AND ELECTRONIC DEVICE UTILIZING THE SAME

(71) Applicant: Samsung Electronics Co., Ltd., Gyeonggi-do (KR)

(72) Inventors: Dong-Ryul SHIN, Daegu (KR); Min SAKONG, Gyeongsangbuk-do (KR); Byung-Chan JANG, Gyeongsangbuk-do (KR); Jin-Woo JUNG, Seoul (KR); Joon-Bo PARK, Busan (KR)

(73) Assignee: Samsung Electronics Co., Ltd.

(21) Appl. No.: 14/836,401

(22) Filed: Aug. 26, 2015

(30) Foreign Application Priority Data
Aug. 26, 2014 (KR) 10-2014-0111689

(51) Int. Cl. H01Q 21/30; H01Q 7/00; H01Q 1/24

(52) U.S. Cl. CPC H01Q 21/30; H01Q 1/243; H01Q 7/00; H01Q 7/005

(57) ABSTRACT

A multi-band loop antenna is provided. The antenna includes a loop radiator that operates in a low frequency band, and at least two loop radiators that operate in a high frequency band and are inserted into an inner area of the low frequency band loop radiator. Each of the radiators independently operates according to an operating frequency band, to provide a multi-band characteristic.

### PRIORITY

The present application claims priority under 35 U.S.C. §119 to a Korean Patent Application filed in the Korean Intellectual Property Office on Aug. 26, 2014, and assigned Serial No. 10-2014-0111689, the contents of which are incorporated herein by reference.

### BACKGROUND

1. Field of the Invention

The present invention generally relates to a multi-band loop antenna of a portable electronic device with a communication function.

2. Description of the Related Art

In recent years, portable electronic devices with a communication function have been produced in miniaturized form, and have grown lighter in weight. There is also a demand for the portable electronic devices to function by receiving mobile communication services in different frequency bands using a single terminal. For example, there is a demand for the single terminal to be capable of simultaneously operating on multi-band signals when necessary, from among mobile communication services using various frequency bands, such as Code-Division Multiple Access (CDMA) service in an 824-894 MHz band and Personal Communication Service (PCS) service in an 1750-1870 MHz commonly used in Korea, CDMA service in a 832-925 MHz commonly used in Japan, PCS service in a 1850-1990 MHz commonly used in U.S., Global System for Mobile communications (GSM) service in an 880-960 MHz band commonly used in Europe or China, and Distributed Control System (DCS) service in a 1710-1880 MHz band commonly used in some countries of Europe, and there is also a demand for a multi-band antenna having a wideband characteristic to receive multi-band service.

However, as the size of a multi-band antenna is reduced, the bandwidth is also reduced, and the demand for a miniaturized multi-band antenna is at odds with the demand for the wideband characteristics.

A general antenna used in a portable electronic device includes a Planar Inverted F Antenna (PIFA) or a monopole radiator as a basic structure, and the volume and the number of antennas mounted in the electronic device may be determined according to a service frequency and a bandwidth. For example, a low frequency band of 700-900 MHz and a high frequency band of 1700-2100 MHz are used as a telephone communication band.

For a monopole antenna, the wideband characteristics are achieved according to the structure of the antenna, but a matching characteristic may be degraded if the antenna is installed adjacent to or in near proximity of a grounded surface, as can occur when the terminal is miniaturized. In addition, for a PIFA, the matching characteristic is enhanced using a grounded pin, but that makes it difficult to achieve the wideband characteristics.

Therefore, there has been an attempt to develop various patterns in order to overcome such limitations, while maintaining the basic structure of the monopole antenna or the PIFA, and various techniques such as miniaturization using a chip antenna or matching using a lumped element have been applied.

However, when the multi-band antenna is miniaturized and the wideband characteristics are implemented using these methods, radiation efficiency is typically degraded.

In addition, the multi-band antenna should operate in various wireless communication services such as Long Term Evolution (LIE), Bluetooth® (BT), Global Positioning System (GPS), and Wireless Fidelity (WiFi). The multi-band antenna should satisfy all of the above-described communication bands with a given antenna volume in a given wireless communication device, should have an electric field below a Specific Absorption Rate (SAR) reference value which is a criterion for determining harmfulness to the human body, and should overcome interference in radiation performance by a metal instrument, such as a metal housing or a Universal Serial Bus (USB).

To overcome these problems, a Metal Device Antenna (MDA) which utilizes a metal instrument as a radiator and a bezel antenna which utilizes a metal housing as a radiator have been suggested.

If the multi-band antenna using the PIFA or the monopole radiator includes a metal housing formed on the exterior thereof, the radiation efficiency of the antenna may be degraded and the interference may arise, even when the antenna has a sufficient inner volume. When a metal instrument such as a USB is adjacent to or in the near proximity of the antenna, the same problems arise.

That is, when a high voltage is induced in an open-ended area of the radiator, the radiator has an electric field as a main component of a near field. The electric field has a coupling effect with a neighboring metallic object, and interference in radiation performance may arise due to the coupling effect.

The MDA structure shows good performance in a metal instrument environment, but is difficult to apply in the metal housing. The bezel antenna structure only provides reduced radiation efficiency due to interference caused when a user holds the device in the user's hand, and interference caused by a neighboring metal instrument. Also, the bezel antenna structure is difficult to design.

In addition, when the antenna is in close proximity to a conductive dielectric material, e.g., blood or muscle, which will be near a wearable device that operates in the proximity of the human body, the electric field serving as a radiation source has high loss resistance and thus radiation performance may be abruptly degraded.

As a radiator to overcome the above-described disadvantages, a loop antenna based on a magnetic field may be used. However, a multi-band technique that operates in a wireless communication band with a given antenna area has not been still suggested.

### SUMMARY

The present invention has been made to address the above-mentioned problems and disadvantages, and to provide at least the advantages described below. An aspect of the present invention provides a multi-band antenna for a portable electronic device with provides a simple design, and has enhanced radiation efficiency, by forming loops which operate in high frequency bands in an inner area of a loop antenna, which can also operate in low frequency bands. Another aspect of the present invention provides a multi-band antenna for a portable electronic device that further enhances performance using an active element such as a variable capacitor or a switch.

Accordingly, an aspect of the present invention provides a multi-band antenna that includes a loop radiator configured to operate in a low frequency band, and at least two loop radiators configured to operate in a high frequency band and are inserted into an inner area of the low frequency band loop radiator, with each of the radiators independently operating according to a frequency band, to provide a multi-band characteristic.

In accordance with an another aspect of the present invention, an electronic device is provided that includes a carrier disposed on one of an upper end and a lower end of the electronic device; a loop radiator formed on the carrier and configured to operate in a low frequency band; at least two loop radiators inserted into an inner area of the low frequency loop radiator, and to operate in a high frequency band; a feeder configured to provide a feeding signal to the radiators; and a grounded portion connected with one end of the low frequency loop radiator, with each of the radiators independently operating according to a frequency band to provide a multi-band characteristic.

### BRIEF DESCRIPTION OF THE DRAWINGS

The above and other aspects, features and advantages of the present invention will become more apparent from the following detailed description, taken in conjunction with the accompanying drawings, in which:

FIG. 1 is a block diagram showing a network environment including an electronic device according to an embodiment of the present invention;

FIG. 2 is a perspective view of a portable electronic device according to an embodiment of the present invention;

FIG. 3 illustrates a basic structure of a multi-band loop antenna according to an embodiment of the present invention;

FIG. 4 illustrates a current distribution of a first loop radiator of a multi-band loop antenna according to an embodiment of the present invention;

FIG. 5 illustrates a current distribution of a second loop radiator of a multi-band loop antenna according to an embodiment of the present invention;

FIG. 6 illustrates a current distribution of a third loop radiator of a multi-band loop antenna according to an embodiment of the present invention;

FIG. 7 is a graph showing radiation efficiency measured in a multi-band loop antenna according to an embodiment of the present invention;

FIG. 8 illustrates a multi-band loop antenna structure coupled with a grounded surface according to an embodiment of the present invention;

FIG. 9 is a graph showing radiation efficiency measured in a multi-band loop antenna coupled with a grounded surface according to an embodiment of the present invention;

FIG. 10 illustrates a multi-band loop antenna structure according to an embodiment of the present invention;

FIG. 11 is a graph showing a change in radiation efficiency of a multi-band loop antenna by a metallic environment according to various embodiments of the present invention; and

FIG. 12 illustrates a multi-band loop antenna structure including an active element according to an embodiment of the present invention.

### DETAILED DESCRIPTION OF THE EMBODIMENTS OF THE PRESENT INVENTION

Herein, embodiments of the present invention are described with reference to the accompanying drawings. Although specific embodiments of the present invention are illustrated in the drawings and relevant detailed descriptions are provided, various changes can be made and various embodiments may be provided. Accordingly, various embodiments of the present invention are not limited to the specific embodiments and should be construed as including all changes and/or equivalents or substitutes included in the ideas and technological scopes of embodiments of the present invention. In the explanation of the drawings, similar reference numerals are used for similar elements.

The terms “include” or “may include” used in describing the embodiments of the present invention indicate the presence of corresponding functions, operations, elements, and the like, and do not limit additional functions, operations, elements, and the like. In addition, it should be understood that the terms “include” or “have” used in describing the embodiments of the present invention indicate the presence of features, numbers, steps, operations, elements, parts, or a combination thereof described in the specifications, and do not preclude the presence or addition of one or more other features, numbers, steps, operations, elements, parts, or a combination thereof.

The term “or” used in describing the embodiments of the present invention include any and all combinations of words enumerated with it. For example, “A or B” means including A, including B, or including both A and B.

Although terms such as “first” and “second” used in describing the various embodiments of the present invention may modify various elements of the various embodiments, these terms do not limit the corresponding elements. For example, these terms do not limit an order and/or importance of the corresponding elements. These terms may be used for the purpose of distinguishing one element from another element. For example, a first electronic device and a second electronic device each indicate electronic devices and may indicate different electronic devices. For example, a first element may be referred to as a second element without departing from the scope of the various embodiments of the present invention, and similarly, a second element may be referred to as a first element.

It will be understood that, when an element is mentioned as being “connected” or “coupled” to another element, the element may be directly connected or coupled to another element, and there may be an intervening element between the element and another element. To the contrary, it will be understood that, when an element is mentioned as being “directly connected” or “directly coupled” to another element, there is no intervening element between the element and another element.

The terms used in describing the present invention are for the purpose of describing specific embodiments only and are not intended to limit various embodiments of the present invention. As used herein, the singular forms are intended to include the plural forms as well, unless the context clearly indicates otherwise. All of the terms used herein including technical or scientific terms have the same meanings as those generally understood by those of ordinary skill in the art unless otherwise defined. The terms defined in a generally used dictionary should be interpreted as having the same meanings as the contextual meanings of the relevant technology and should not be interpreted as having ideal or exaggerated meanings unless clearly defined herein.

An electronic device according to various embodiments of the present invention includes a device that is equipped with a communication function. For example, the electronic device may include at least one of a smartphone, a tablet personal computer (PC), a mobile phone, a video phone, an electronic book reader, a desktop PC, a laptop PC, a netbook computer, a Personal Digital Assistant (PDA), a Portable Multimedia Player (PMP), an MP3 player, a mobile medical machine, a camera, or a wearable device (for example, a head-mounted-device (HMD) such as electronic glasses, electronic clothing, an electronic bracelet, an electronic necklace, an electronic appcessory, electronic tattoos, or a smart watch).

The electronic device according to various embodiments of the present invention includes one or a combination of one or more of the above-mentioned devices. In addition, the electronic device according to various embodiments of the present invention may be a flexible device. In addition, one of ordinary skill in the related art will recognize that the electronic device according to various embodiments of the present invention is not limited to the above-mentioned devices.

Hereinafter, an electronic device according to various embodiments is explained with reference to the accompanying drawings. The term “user” used in the various embodiments may refer to a person who uses the electronic device or a device that uses the electronic device (for example, an artificial intelligence electronic device).

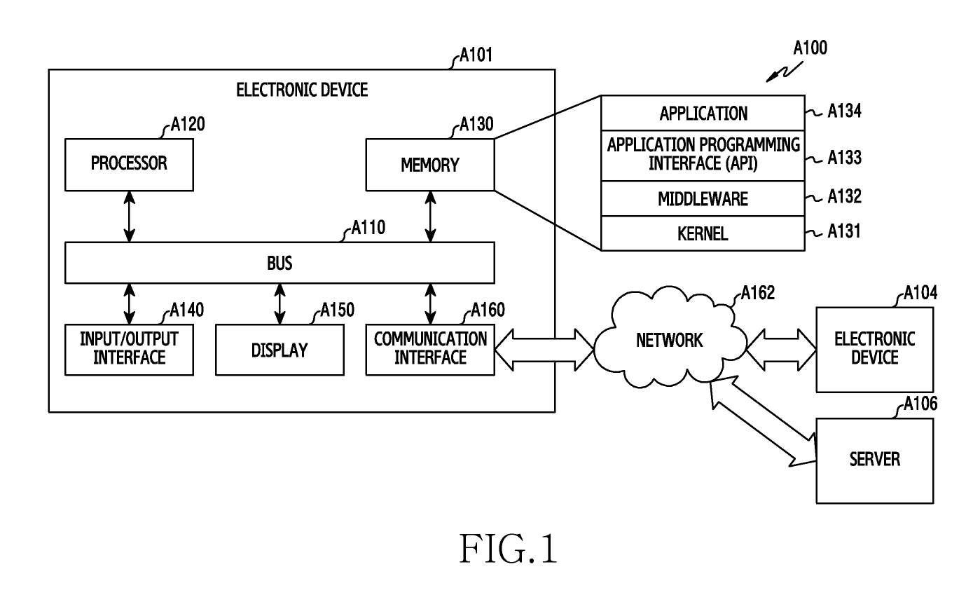

FIG. 1 is a block diagram showing a network environment including an electronic device according to an embodiment of the present invention. Referring to FIG. 1, the electronic device A101 includes a bus A110, a processor A120, a memory A130, an input and output interface A140, a display A150, and a communication interface A160.

The bus A110 may be a circuit which connects the above-described elements with one another and transmits communication (for example, a control message) between the above-described elements.

The processor A120 receives instructions from the other elements (for example, the memory A130, the input and output interface A140, the display A150, the communication interface A160, and the like) via the bus A110, deciphers the instructions, and performs calculation and/or data processing according to the deciphered instructions.

The memory A130 stores instructions or data received from or generated by the processor A120 or the other elements (for example, the input and output interface A140, the display A150, the communication interface A160, and the like). For example, the memory A130 may include programming modules such as a kernel A131, middleware A132, an Application Programming Interface (API) A133, an application A134, and the like. Each of the above-described programming modules may be configured by software, firmware, hardware, or a combination of two or more of them.

The kernel A131 controls or manages system resources (for example, the bus A110, the processor A120, the memory A130, and the like) which are used for performing operations or functions implemented in the other programming modules, for example, the middleware A132, the API A133, or the application A134. In addition, the kernel A131 may provide an interface for allowing the middleware A132, the API A133, or the application A134 to access an individual element of the electronic device A100 and control or manage the element.

The middleware A132 serves as an intermediary to allow the API A133 or the application A134 to communicate with the kernel A131, and exchanges data with the kernel A131. In addition, the middleware A132 controls, e.g. schedules or load balances, work requests received from the application A134, for example, by giving priority to use the system resources of the electronic device A100 to at least one application.

The API A133 may be an interface for allowing the application A134 to control a function provided by the kernel A131 or the middleware A132, and, for example, may include at least one interface or function (for example, instructions) for controlling a file, controlling a window, processing an image, or controlling a text.

According to various embodiments, the application A134 may include a Short Message Service (SMS)/Multimedia Messaging Service (MMS) application, an email application, a calendar application, a notification application, a health care application (for example, an application for measuring exercise or blood sugar), an environment information application (for example, an application for providing information on atmospheric pressure, humidity, or temperature), and the like. Additionally or alternatively, the application A134 may be an application related to information exchange between the electronic device A100 and an external electronic device (for example, another electronic device A104). For example, the application related to the information exchange may include a notification relay application for relaying specific information to an external electronic device or a device management application for managing an external electronic device.

For example, the notification relay application may include a function of relaying notification information generated by other applications of the electronic device A100 (for example, the SMS/MMS application, the email application, the health care application, the environment information application, and the like) to the external electronic device A104. Additionally or alternatively, the notification relay application may receive notification information from the external electronic device A104 and may provide the same to a user. For example, the device management application may manage (for example, install, delete or update) a function regarding at least part of the external electronic device A104 communicating with the electronic device A100 (for example, turning on/off the external electronic device (or some parts) or adjusting brightness (or resolution) of a display), an application operating in the external electronic device or a service provided by the external electronic device (for example, a calling service or a message service).

According to various embodiments, the application A134 may include an application which is specified according to the attribute (for example, a type of electronic device) of the external electronic device A104. For example, when the external electronic device is an MP3 player, the application A134 may include an application related to music replay. Similarly, when the external electronic device is a mobile medical device, the application A134 may include an application related to health care. According to an embodiment, the application A134 may include at least one of an application specified by the electronic device A100 or an application received from an external electronic device (for example, a server A106 or the other electronic device A104).

The input and output interface A140 may transmit instructions or data inputted by the user through an input and output device (for example, a sensor, a keyboard or a touch screen) to the processor A120, the memory A130, or the communication interface A160 through the bus A110, for example. For example, the input and output interface A140 may provide data on a user's touch inputted through a touch screen to the processor A120. In addition, the input and output interface A140 may output instructions or data received from the processor A120, the memory A130, or the communication interface A160 through the bus A110 through the input and output device (for example, a speaker or a display). For example, the input and output interface A140 may output voice data processed through the processor A120 to the user through a speaker.

The display A150 displays a variety of information (for example, multimedia data, text data, and the like) to the user.

The communication interface A160 enables communication between the electronic device A100 and an external electronic device A104 or server A106. For example, the communication interface A160 may be connected to a network A162 via wireless communication or wire communication to communicate with the external device. The wireless communication may include at least one of WiFi, BT, Near Field Communication (NFC), a GPS, or cellular communication (for example, LTE, LTE-A, CDMA, WCDMA, UMTS, WiBro, GSM, and the like). The wire communication may include at least one of a USB, a High Definition Multimedia Interface (HDMI), a Recommended Standard 232 (RS-232), or plain old telephone service (POTS).

According to various embodiments, the network A162 may be a telecommunications network. The telecommunications network may include at least one of a computer network, Internet, Internet of Things, or a telephone network. According to an embodiment, a protocol for communicating between the electronic device A101 and the external device (for example, a transport layer protocol, a data link layer protocol or a physical layer protocol) may be supported in at least one of the application A134, the application programming interface A133, the middleware A132, the kernel A131, or the communication interface A160.

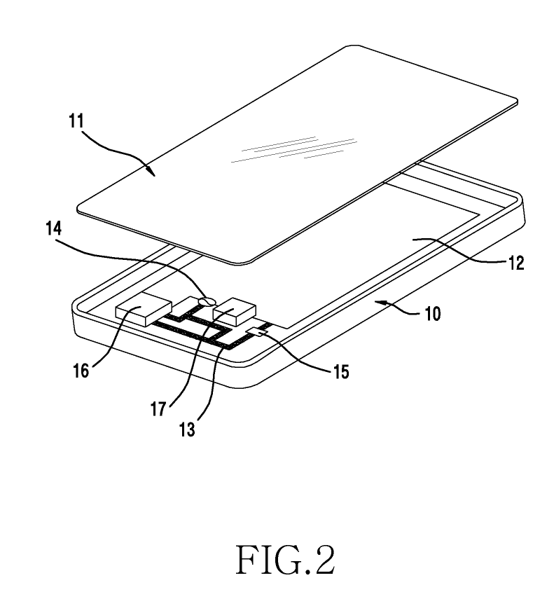

Hereinafter, a multi-band loop antenna according to various embodiments of the present invention is explained with reference to FIGS. 2 to 12. FIG. 2 is a perspective view of a portable electronic device employing an antenna according to an embodiment of the present invention.

Referring to FIG. 2, embodiments of the present invention provide a multi-band loop antenna in a portable electronic device with a wireless communication function, which is used to transmit and receive radio waves and can prevent degradation of radiation efficiency and a change in resonant frequency, in spite of the presence of communication performance interfering elements, such as an external metal cover 11, a metal housing or metal casing 10, or metal instruments 16, 17. In addition, various embodiments of the present invention provide an antenna 13 which includes at least two high frequency loop radiators operating independently in a low frequency loop radiator area, and feeding portion 14. Furthermore, various embodiments of the present invention provide an antenna which further includes an active element such as a variable capacitor 15 such as one or more variable capacitors, and thus further enhances performance.

A portable electronic device according to various embodiments of the present invention include a metal casing 10, a grounded surface 12, the external metal cover 11, and a multi-band loop antenna 13. The metal casing 10 may be configured as a housing for accommodating and protecting a substrate and parts of the portable electronic device. The metal casing 10 may be referred to as a metal housing. The metal cover 11, which is a rear casing of the portable electronic device, may include a battery casing or an accessory casing. The metal cover 11 may be attachably and detachably connected with the metal casing 10. The metal casing 10 and the metal cover 11 are connected with each other to form the exterior of the portable electronic device. The attachable/detachable structure of the metal casing 10 and the metal cover 11 may be omitted and the metal casing 10 and the metal cover 11 may be provided with a locking protrusion and a locking hole.

The antenna 13, which is a multi-band loop radiator, has a multi-loop structure. In the loop structure of the antenna radiator, one or more metal instruments such as a USB may be installed in an inner area or an adjacent area without changing the structure of the loop antenna.

In addition, the metal casing 10 having various structures such as an integrated or segmented structure may be installed on the radiator having the multi-loop structure to enclose a part or entirety of the multi-loop structure. The metal cover 11 has an open-ended antenna area and may be disposed on the upper end or the lower end of the portable electronic device.

In addition, the antenna may have the variable capacitor 15 or the switch connected to the loop radiator in series or in parallel.

The antenna 13 according to various embodiments of the present invention is designed to satisfy the following conditions: when a loop line length approximates a wavelength of an operating frequency, the antenna has a high input matching characteristic, and has radiation efficiency which is proportional to the size of the inner area of the loop line. The loop antenna has a magnetic field as a main near field. When the above-described design condition is satisfied, radiation performance is not easily degraded in response to an environmental change such as approach of a metallic conductor, a human body, and a dielectric material in comparison with the PIFA and monopole-based multi-band antenna.

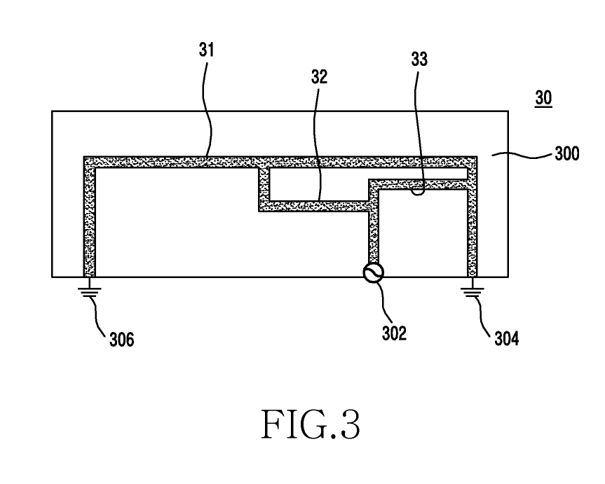

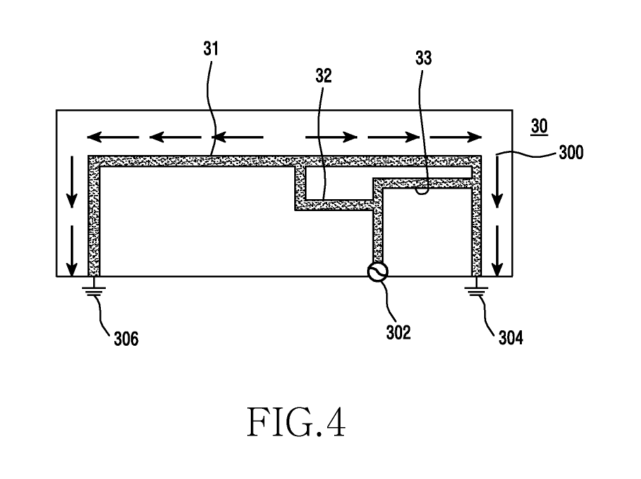

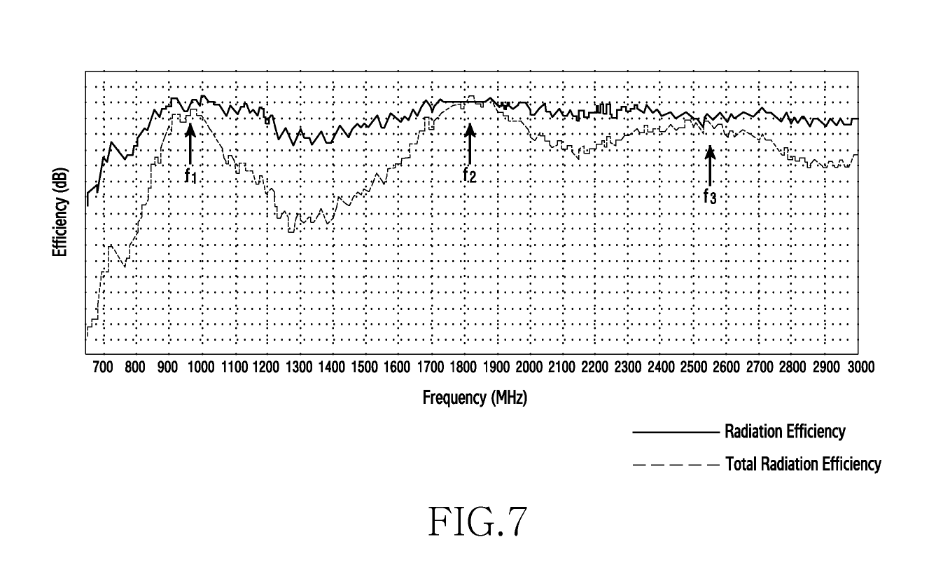

FIG. 3 illustrates a basic structure of a multi-band loop antenna 30 according to an embodiment of the present invention. FIGS. 4 to 6 illustrate current distribution of a first loop radiator, a second loop radiator, and a third loop radiator, respectively, of an multi-band loop antenna according to embodiments of the present invention. FIG. 7 is a graph showing radiation efficiency of a loop radiator of an antenna according to an embodiment of the present invention.

Referring to FIG. 3, the antenna 30 includes a carrier 300, a plurality of loop radiators 31-33, and a feeder 302. The carrier 300 is made of a dielectric material and serves as a body for supporting the plurality of loop radiators 31-33. A plurality of radiators are formed on the carrier 300. The loop radiators 31-33 are made of a metallic material and include a loop radiator 31 that is configured to operate in, i.e., satisfy, a low frequency band and at least two loop radiators 32, 33 that are configured to operate in a high frequency band. The at least two loop radiators 32, 33 are inserted into the inner area of the low frequency band loop radiator 31. The loop radiator satisfying the low frequency band is referred to as a first loop radiator 31, and the at least two loop radiators are referred to second and third loop radiators 32, 33, respectively. The first, second, and third loop radiators 31-33 are formed in a regularly linear pattern and are electrically connected with one another. A resonance point of the antenna 30 is adjusted by connecting the second and third loop radiators 32, 33 to the first loop radiator 31, so that the antenna 30 has a wideband, i.e., multi-band, characteristic.

The resonant frequency of the antenna 30 is a factor that is determined by the length of the loop radiator. The loop radiator has one end provided with the feeder 302 to receive a Radio Frequency (RF) signal. In addition, the loop radiator has the other ends connected with two grounded portions 304, 306.

FIG. 4 illustrates a current distribution of the first loop radiator of the multi-band loop antenna 30 according to an embodiment of the present invention. Referring to FIG. 4, in a first resonance mode of the antenna, the loop structure of the loop radiator is configured to operate in the lowest frequency band from among the frequency bands and has a current distribution along the outermost line of the loop radiator.

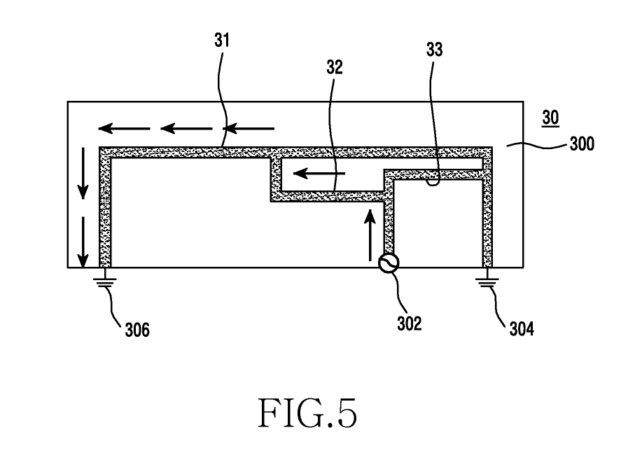

FIG. 5 illustrates a current distribution of the second loop radiator of the multi-band loop antenna according to an embodiment of the present invention. Referring to FIG. 5, in a second resonance mode of the antenna, the loop structure is configured to operate in a high frequency band and has a current distribution along a line formed by a part of the third loop radiator, a part of the second loop radiator, and a part of the first loop radiator.

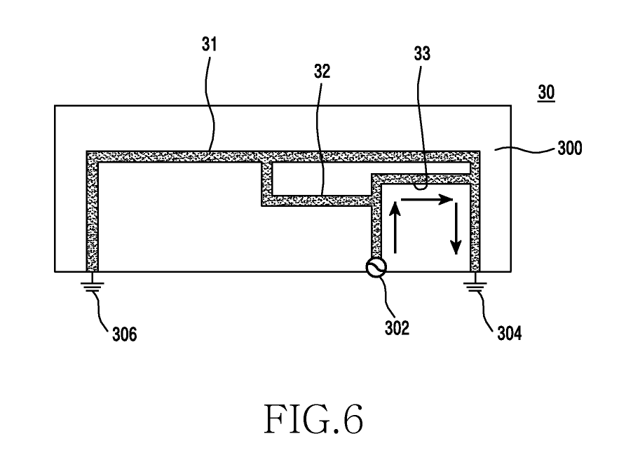

FIG. 6 illustrates a current distribution of the third loop radiator of the multi-band loop antenna according to an embodiment of the present invention. Referring to FIG. 6, in a third resonance mode of the antenna, the loop structure is configured to operate in a high frequency band and has a current distribution along the third loop radiator.

As a result, in the multi-band antenna 30 according to the present invention, the second loop radiator 32 and the third loop radiator 33 existing in, i.e., inserted into, the first loop radiator 31, operate with independent current distributions according to respective resonance modes.

FIG. 7 is a graph showing radiation efficiency measured in the first, second, and third resonance modes (f₁, f₂, f₃) in the multi-band loop antenna 30 according to an embodiment of the present invention. Referring to FIG. 7, the radiation efficiency of the antenna is uniform in the frequency band of the first loop radiator, the frequency band of the second loop radiator, and the frequency band of the third loop radiator.

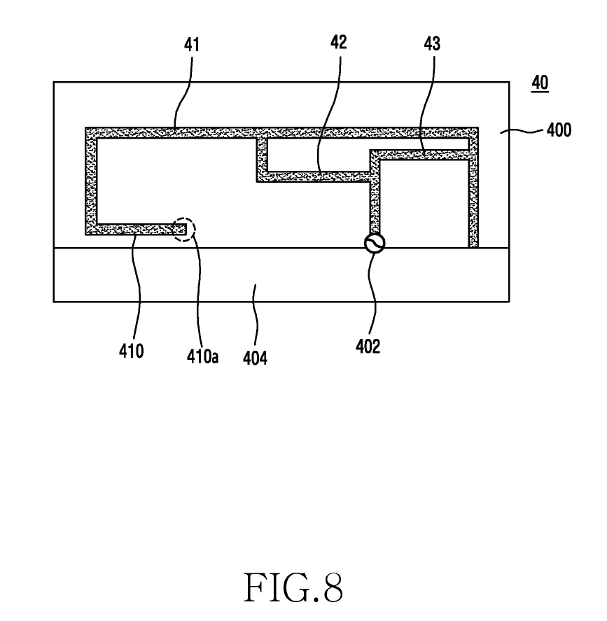

FIG. 8 illustrates a multi-band loop antenna 40 in which a radiator line 410 and a grounded surface 404 are electrically coupled according to an embodiment of the present invention. The multi-band antenna 40 implements both the connection between a line of a plurality of loop radiators 41-43 and the grounded surface 404, and an electrical coupling connection between the line of loop radiators 41-43 and the grounded surface 404.

The antenna 40 includes a carrier 400, the plurality of loop radiators 41-43, a feeder 402, and the grounded surface 404. The carrier 400 is made of a dielectric material and serves as a body for supporting the plurality of radiators 41-43. Each of the loop radiators 41-43 is made of a metallic material. The loop radiator 41 operates in the low frequency band and the at least two loop radiators 42, 43 operate in the high frequency band. The at least two high frequency band loop radiators 42, 43 are inserted into the inner area of the low frequency band loop radiator 41. The first, second and third loop radiators 41-43 are electrically connected with one another. The multi-band loop antenna adjusts the resonance point of the antenna 40 by connecting the second and third loop radiators 42, 43 to the first loop radiator 41, so that the antenna 40 has a wideband, i.e., multi-band, characteristic.

The radiator has one end provided with the feeder 402 to receive an RF signal. In addition, the radiator has its other end connected with the grounded surface 404 and the other end is configured with an open end. A physical connection between the radiator line 410 of the open-end the first loop radiator and the grounded surface 404 are implemented by the electrical coupling.

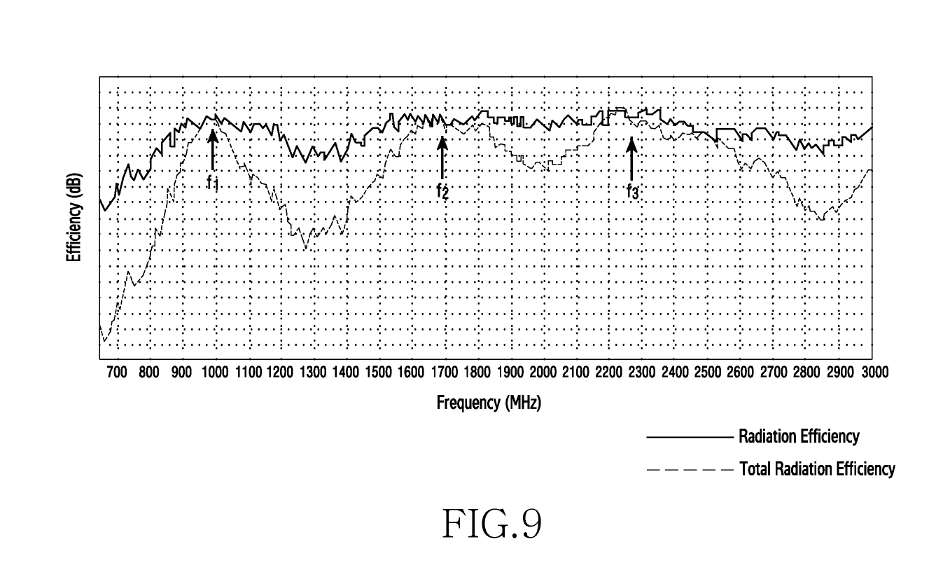

FIG. 9 is a graph showing radiation efficiency measured in the multi-band loop antenna 40 according to an embodiment of the present invention. Referring to FIG. 9, the radiation efficiency of the antenna is uniform in the frequency band of the first loop radiator, the frequency band of the second loop radiator, and the frequency band of the third loop radiator. The horizontal axis in the graph of FIG. 9 indicates a frequency (Hz) and the vertical axis indicates a radiation loss in decibels (dB).

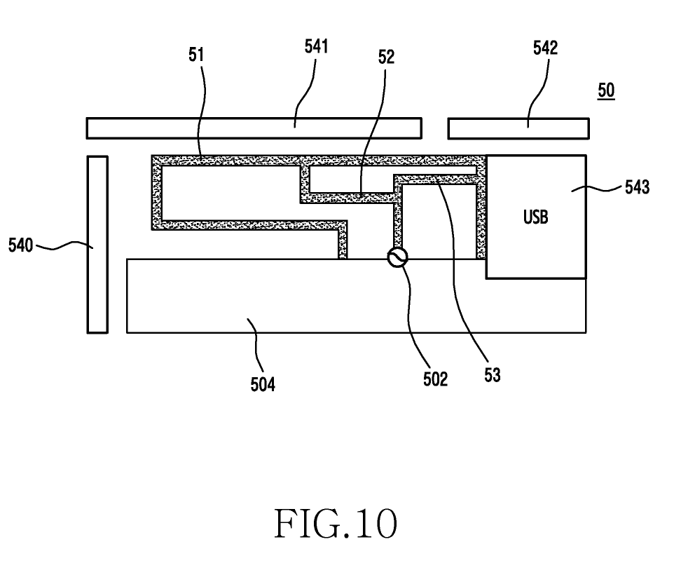

FIG. 10 illustrates a multi-band loop antenna structure according to an embodiment of the present invention. In FIG. 10, an antenna radiation area of a portable electronic device is provided in a structure of a multi-band loop antenna 50, which includes first to third metal housings 540-542 and a metal instrument 543 according to the present invention.

Referring to FIG. 10, the antenna 50 includes a plurality of loop radiators 51-53, a grounded surface 504, a feeder 502, and a plurality of metallic articles formed by the first to third metal housings 540-542 and the metal instrument 543. Each loop radiator of the plurality of loop radiators 51-53 is made of a metallic material. Loop radiator 51 is configured to operate in the low frequency band and the at least two loop radiators 52, 53 are configured to operate in the high frequency band. The at least two high frequency band loop radiators 52, 53 are inserted into the inner area of the low frequency band loop radiator 51. The loop radiators 51-53 are electrically connected with one another. The antenna 50 adjusts the resonance point of the antenna by connecting the second and third loop radiators 52, 53 to the first loop radiator 51, so that the antenna 50 has a wideband, i.e. multi-band, characteristic.

The resonant frequency of the antenna 50 is determined by the length of each of the loop radiators. The loop radiator has one end provided with the feeder 502 to receive an RF signal. In addition, the loop radiator has the other end connected with the grounded surface 504.

The plurality of metallic articles includes metal housing 540-542 and metal instrument 543. A single metal housing or a plurality of metal housings is provided. The metal housing is an external metal article forming a part of the exterior of the electronic device, and may have an integral non-segmented structure through electric contact or mechanical design in order to prevent from being utilized as a radiator.

In addition, in the multi-band loop antenna 50 according to the present invention, the first to third metal housings 540-542 are segmented from the upper end of the antenna to avoid unnecessary magnetic coupling. Positions of segments of the first to third metal housings can be comparatively freely set without interfering with performance. One or more metal housings may be provided, and the first to third metal housings 540-542 may have a connected structure or segmented structure.

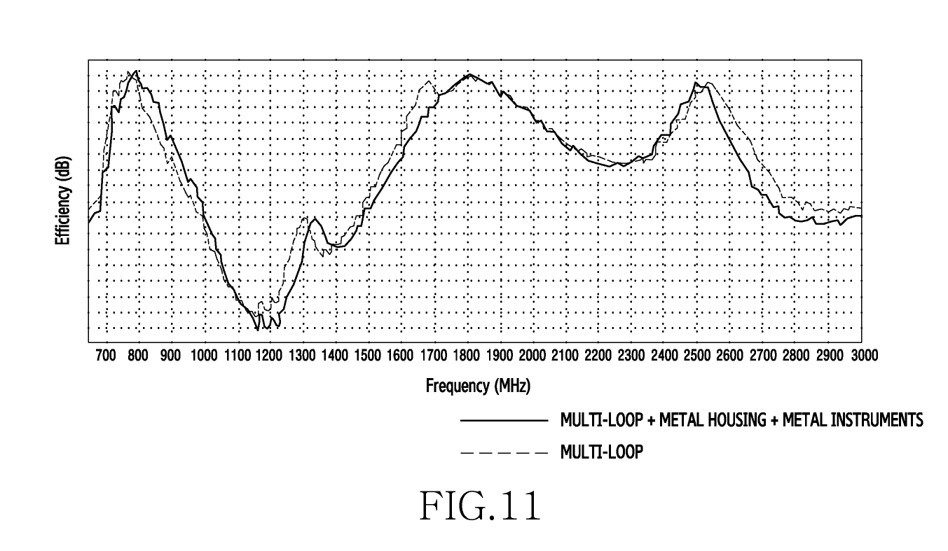

FIG. 11 is a graph showing a change in radiation efficiency of a multi-band loop antenna by a metallic environment according to various embodiments of the present invention. FIG. 11 shows radiation efficiency measured in the multi-band loop antenna 50. Even when the plurality of metal housings 540-542 and the metal instrument 543 are disposed adjacent to or in the near proximity of the multi-band loop antenna 50, the antenna has similar radiation efficiency in each frequency band, compared to the absence of metallic articles. That is, the multi-band loop antenna 50 of the present invention is rarely influenced by an environment that includes metallic articles.

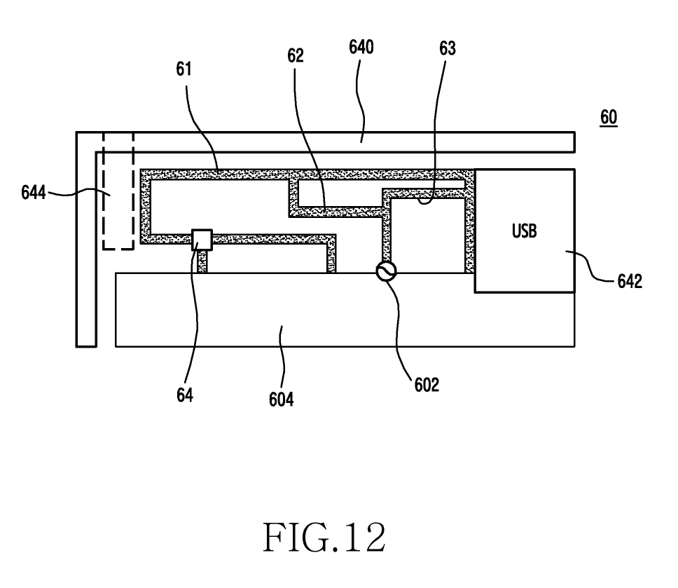

FIG. 12 illustrates a multi-band loop antenna structure including an active element according to an embodiment of the present invention. FIG. 12 shows an antenna 60 of a portable electronic device which utilizes a switch 64, which is an active element. The antenna includes first, second, and third loop radiators 61-63, a grounded surface 604, a feeder 602, and the switch 64. The antenna 60 has the switch 64 connected with one end of the first loop radiator to adjust the length of an antenna line, so that the loop antenna can adjust an operating frequency. The antenna 60 can provides the same performance by connecting a variable capacitor instead of the switch 64. In addition, the antenna 60 may include a metal housing 640 and a plurality of metal instruments 642, 644.

In addition, in the multi-band loop antenna of the present invention, the metal housing 640 may be segmented from the upper end of the antenna to avoid unnecessary magnetic coupling, and the positions of the segment can be comparatively freely set without influencing performance of the antenna. The plurality of metal instruments 642, 644 are disposed in the near proximity of the loop radiator and are connected with the metal housing or disposed independently. The plurality of metal instruments may include a USB connector 642 and an ear jack connector 644.

According to the present invention, even when the metal housing 640 and the plurality of metal instruments 642, 644 are disposed adjacent to or in the near proximity of the multi-band loop antenna 60, the antenna 60 has similar radiation efficiency in each frequency band, compared to the absence of metallic articles. That is, the multi-band loop antenna 60 of the present invention is rarely influenced by an environment that includes metallic articles.

According to the present invention, at least two high-frequency loop antennas are implemented in the same volume as a low frequency loop antenna, so that the antenna is rarely influenced by a metal cover, a metal housing or a metal instrument, to increase the available internal volume of a device utilizing such antenna, to enhance radiation efficiency, and to provided a simplified design.

At least part of the apparatus of the present invention may be implemented by using instructions stored in a computer-readable storage medium in the form of a programming module. When the instructions are executed by one or more processors, the one or more processors may perform a function corresponding to the instructions. The computer-readable storage medium may be a memory, for example. At least part of the programming module may be implemented (for example, executed) by using the processor. At least part of the programming module may include a module, a program, a routine, sets of instructions, a process, and the like for performing one or more functions.

Examples of a computer-readable recording medium include magnetic media such as hard disks, floppy disks and magnetic tapes, optical media such as Compact Disc Read Only Memories (CD-ROMs) and Digital Versatile Disc (DVDs), magneto-optical media such as floptical disks, and hardware devices such as Read Only Memories (ROMs), Random Access Memories (RAMs) and flash memories configured to store and execute program commands (for example, the programming module). Examples of the program commands include machine language codes created by a compiler, and high-level language codes that can be executed by a computer by using an interpreter. The above-described hardware devices may be configured to operate as one or more software modules for performing operations of embodiments of the present invention, and vice versa.

A module or programming module according to various embodiments of the present invention may include one or more of the above-described elements, may omit some elements, or may further include additional other elements. The operations performed by the module, the programming module, or the other elements according to the present invention may be performed serially, in parallel, repeatedly, or heuristically. In addition, some operation may be performed in different order or may be omitted, and an additional operation may be added.

While the invention has been shown and described with reference to certain embodiments thereof, it will be understood by those skilled in the art that various changes in form and details may be made therein without departing from the spirit and scope of the invention, as defined by the appended claims. Therefore, the scope of the invention is defined not by the detailed description of the invention but by the appended claims, and all differences within the scope will be construed as being included in the present invention.

What is claimed is:

1. A multi-band antenna comprising:
a loop radiator configured to operate in a low frequency band; and
at least two loop radiators configured to operate in a high frequency band and inserted into an inner area of the low frequency band loop radiator,
wherein each of the radiators independently operates according to an operating frequency band, to provide a multi-band characteristic.

2. The multi-band antenna of claim 1, wherein each of the radiators are connected with one another on a carrier and have at least one end connected to a grounded portion.

3. The multi-band antenna of claim 2, wherein each of the loop radiators has an independent current distribution according to the operating frequency band.

4. The multi-band antenna of claim 1, wherein an open end of the low frequency band loop radiator is physically connected with a grounded surface and electrically coupled to the grounded surface.

5. The multi-band antenna of claim 1, wherein the low frequency band loop radiator has at least one metal instrument disposed in one of the inner area and an external area thereof.

6. The multi-band antenna of claim 5, wherein the at least one metal instrument comprises one of a Universal Serial Bus (USB) connector and an ear jack connector.

7. The multi-band antenna of claim 3, wherein the low frequency band loop radiator includes at least one metal housing disposed in an external area thereof.

8. The multi-band antenna of claim 6, wherein the at least one metal housing encloses at least part of the low frequency band loop radiator.

9. The multi-band antenna of claim 8, wherein a plurality of metal housings form one of an integrated structure and a segmented structure.

10. The multi-band antenna of claim 1, further comprising one of a switch and a variable capacitor configured to adjust a length of a line of the low frequency band loop radiator and selectively adjust between the low frequency band to a high frequency band.

11. The multi-band antenna of claim 3, wherein each of the radiators has a metal cover disposed on an external area thereof.

12. The multi-band antenna of claim 11, wherein the metal cover comprises a removable battery cover.

13. An electronic device comprising:
a carrier disposed on one of an upper end and a lower end of the electronic device;
a loop radiator formed on the carrier and configured to operate in a low frequency band;
at least two loop radiators inserted into an inner area of the low frequency band loop radiator and to operate in a high frequency band;
a feeder configured to provide a feeding signal to the radiators; and
a grounded portion connected with one end of the low frequency band loop radiator,
wherein each of the radiators operates independently to provide a multi-band characteristic.

14. The electronic device of claim 13, wherein one of an integrated metal article and a segmented metal article is disposed adjacent to the low frequency band loop radiator.

15. The electronic device of claim 14, wherein the integrated metallic article comprises one of a metal housing, an ear jack connector, a Universal Serial Bus (USB) connector disposed in the metal housing, and a combination thereof.
